(19) United States
(12) Patent Application Publication
(10) Pub. No.: US 2003/0199623 A1
(43) Pub. Date: Oct. 23, 2003

(54) Insulating composition for a security electric cable

(76) Inventors: Jean-Noel Demay, Vernaison (FR); Martine Lejeune, Limoges (FR); Michel Gardelein, Ecully (FR); Christelle David, Villeurbanne (FR)

Correspondence Address: SOFER & HAROUN, L.L.P., Suite 910, 317 Madison Avenue, New York, NY, 10017, US

(21) Appl. No.: 10/389,682

(22) Filed: Mar. 14, 2003

(30) Foreign Application Priority Data
Mar. 22, 2002 (FR) 02 03867

(51) Int. Cl. C08K 3/18; C08K 3/22; C08K 3/34; C08K 3/38

(52) U.S. Cl. 524/405; 524/430; 524/492

(57) ABSTRACT

The present invention relates to an electrically insulating composition that withstands high temperature T, the composition comprising a first component constituted by an organic polymer having a decomposition temperature lower than said temperature T, a second component constituted by a fusible ceramic filler having a melting temperature lower than said temperature T, and a third component constituted by a refractory filler having a melting temperature higher than said temperature T. According to the invention, the fusible ceramic filler content is less than or equal to 50 parts by weight per 100 parts by weight of polymer.

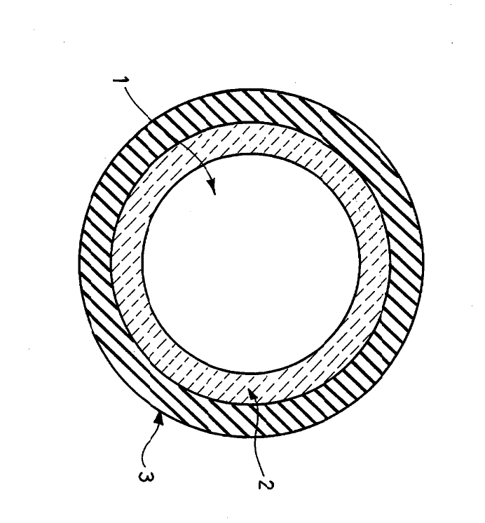

The present invention relates to an insulating composition for a fireproof security electric cable.

### BACKGROUND OF THE INVENTION

Such an electric cable has the property of continuing to operate for a length of time defined by fire testing standards, and to do so in a manner that is completely safe for its environment. The layer of insulating material surrounding the conductor must therefore conserve its ability to insulate over a range of temperatures extending from 20°0 C. to 1100°0 C., and it must present ash having sufficient mechanical cohesion.

A known composition for a fireproofing insulating layer is described in patent document WO 98/43251.

That insulating layer comprises a first component constituted by silicone rubber or a monomer or a polymer of ethylene and propylene, a second component constituted by a fusible ceramic filler, and a third component constituted by a refractory oxide.

In that prior patent document, it is proposed more specifically to use ethylene-propylene terpolymer or ethylene-propylene diene monomer as the first component. A high content of fusible ceramic filler is also used, possibly more than 200 parts by weight of filler for 100 parts by weight of polymer.

Such a composition presents several technical problems.

The first component, silicone rubber or monomer or ethylene and propylene polymer requires peroxide cross-linking treatment.

Furthermore, although the fusible ceramic filler enables a glass to be formed which provides the insulation with good resistance to fire, it turns out that its high content is prejudicial to the quality of the electrical insulation provided by the insulation. Too great a filler content is also a drawback for making the composition extrudable and curable.

It turns out that mixtures having a high concentration of filler and peroxide lead to a composition with high viscosity and that is self-heating to a large extent while the components are being mixed together, thereby leading to early decomposition of the peroxide and to the appearance of a grilling phenomenon, in which the composition becomes partially cross-linked within the mixer. The grilling phenomenon can also occur during extrusion due to excessive mechanical self-heating because of the high viscosity of the composition.

### OBJECTS AND SUMMARY OF THE INVENTION

The invention resolves those problems by providing a good compromise between the thermal insulation and electrical insulation properties of the insulation, and to do this it proposes an electrically insulating composition that withstands high temperature T, the composition comprising a first component constituted by an organic polymer having a decomposition temperature lower than said temperature T, a second component constituted by a fusible ceramic filler having a melting temperature lower than said temperature T, and a third component constituted by a refractory filler having a melting temperature higher than said temperature T, wherein the fusible ceramic filler content is less than or equal to 50 parts by weight per 100 parts by weight of polymer.

This high temperature T is advantageously the maximum fire test temperature, i.e. 1100°0 C.

In a preferred embodiment, said polymer is ethylene copolymer.

Advantageously, said polymer is ethylene-octene copolymer or a mixture based on ethylene-octene copolymer.

Preferably, said fusible ceramic filler is selected from: boron oxide (B₂O₃); zinc borates (4ZnO B₂O₃ H₂O or 2ZnO 3B₂O₃ 3.5H₂O); and anhydrous or hydrated boron phosphates (BPO₄), or a mixture of these components. This fusible ceramic filler has a melting point below 500° C. and gives rise to a glass under the effect of temperature.

Preferably, said refractory filler is selected from magnesium oxide MgO, silicon oxide (SiO₂), aluminum oxide (Al₂O₃), and muscovite mica (6SiO₂-3Al₂O₃—K₂O-2H₂O) or a mixture of these fillers.

The composition is made either by thermoplastic mixing or by silane cross-linking, e.g. using the sioplas technique. In which case, zinc borate is the most appropriate fusible ceramic filler. Such cross-linking requires less equipment and permits higher rates of extrusion than does peroxide cross-linking. In addition, such cross-linking does not exert pressure on the components of the cable since it takes place at atmospheric pressure or at very low steam pressure, unlike peroxide cross-linking which is conventionally performed in a steam tube at high pressure.

It should be observed that using a totally degradable polymer as the first component makes it possible, by an appropriate choice of the refractory filler, to obtain a ratio of the expansion coefficient of the metal forming the conductor to the expansion coefficient of the filler that is close to 1. For example, over the range 20°0 C. to 1000°0 C., the expansion coefficient of silica is 4υ10⁻⁶/° C., whereas that of copper is 18υ10⁻⁶/° C., and that of magnesium oxide is 12 υ10⁻⁶/° C. to 14υ10⁻⁶/° C. An insulating cable filled with magnesium oxide therefore has better mechanical performance than a cable filled with silica after the silicone rubber has decomposed.

This composition remains electrically insulating over a wide range of temperatures, about 20°0 C. to 1100°0 C., and thus enables the conductor to continue to be insulated under fire conditions by transforming into a hard ceramic layer. In ordinary use of an electric cable coated in a layer constituted by such a composition, i.e. in use at ambient temperature, it is the polymer which insulates the conductor and provides the cable with its mechanical strength and flexibility. At high temperatures, in particular in the event of a fire, the polymer is completely degraded; it is thus the refractory filler that is present which takes over in terms of providing electrical insulation and which forms a hard and insulating ceramic layer around the conductor under the sintering due to the glass formed by the fusible ceramic filler.

By way of example, the composition of the invention is made in an internal mixer with an additional step of premixing the inorganic fillers with each other using a blade mixer so as to obtain a uniform distribution of the fusible ceramic filler within the likewise ceramic refractory filler such as magnesium oxide, thereby increasing the cohesion of the ceramic layer.

In a first preferred specific embodiment, the composition comprises:

100 parts by weight of ethylene-octene copolymer;

100 to 200 parts by weight of magnesium oxide;

5 to 50 parts by weight of boron oxide or of zinc borate or of boron phosphate; and

5 to 150 parts by weight of other fillers and processing agents and protection agents.

Given the highly refractive nature of magnesium oxide whose melting temperature is about 2800°0 C., it is preferable to use an oxide that melts well such as boron oxide so as to wet the grains of magnesia and enhance sintering thereof in a fire.

In a second preferred specific embodiment, the composition comprises:

100 parts by weight of ethylene-octene copolymer;

100 to 200 parts by weight of muscovite mica;

5 to 50 parts by weight of boron phosphate or of zinc borate; and

5 to 150 parts by weight of other fillers and processing agents and protection agents.

The invention also provides an electric cable comprising at least one conductor 1 coated in an inner first layer 2 of insulation and an outer second layer 3 of insulation, said first layer 2 being constituted by a composition in accordance with the first above specific embodiment presenting electrical insulation properties that are particularly high, and the second layer 3 being constituted by a composition in accordance with the second specific embodiment.

Such a cable thus has two layers of insulation. The first layer 2 in contact with the conductor 1, e.g. a copper conductor, provides electrical insulation while temperature is rising, and the outer second layer 3 provides mechanical strength at high temperatures by forming a hard crust around the conductor.

These two layers are advantageously coextruded.

Examples of insulating compositions in accordance with the invention are given below as examples:

Mica-based compositions:

| | |
|---|---|
| Example 1 | 55 phr ethylene-vinyl acetate copolymer |
| | +25 phr ethylene-propylene diene |
| | terpolymer |
| | +20 phr ethylene-acrylic ester - maleic |
| | anhydride terpolymer |
| | or 100 phr of ethylene-octene copolymer |
| | 5 to 50 phr zinc borate or boron |
| | phosphate |
| | 100 to 200 phr mica |
| | 0 to 60 phr aluminum trihydrate or |
| | magnesium dihydrate |
| | 5 to 15 phr wax |
| | 0 to 5 phr ZnO |
| | 2 to 15 phr silane |
| | 2 to 5 phr antioxidizer |
| | 0 to 15 phr cross-linking agent |
| Example 2 | 55 phr ethylene-octene copolymer |
| | 25 phr ethylene-propylene diene |
| | terpolymer |
| | 20 phr ethylene-acrylic ester copolymer |
| | 5 to 50 phr zinc borate or boron |
| | phosphate |
| | 100 to 200 phr mica |
| | 0 to 60 phr aluminum trihydrate or |
| | magnesium dihydrate |
| | 5 to 15 phr wax |
| | 0 to 5 phr ZnO |
| | 2 to 15 phr silane |
| | 2 to 5 phr antioxidizer |
| | 0 to 15 phr cross-linking agent |
| Example 3 | 75 phr ethylene-octene copolymer |
| | 25 phr ethylene-acrylic ester copolymer |
| | 5 to 50 phr zinc borate or boron |
| | phosphate |
| | 100 to 200 phr mica |
| | 0 to 60 phr aluminum trihydrate or |
| | magnesium dihydrate |
| | 5 to 15 phr wax |
| | 0 to 5 phr ZnO |
| | 2 to 15 phr silane |
| | 2 to 5 phr antioxidizer |
| | 0 to 15 phr cross-linking agent |

Compositions based on magnesium oxide (MgO):

| | |
|---|---|
| Example 4 | 75 phr ethylene-octene copolymer |
| | 25 phr ethylene-acrylic ester copolymer |
| | 5 to 50 phr zinc borate or boron |
| | phosphate |
| | 100 to 200 phr MgO |
| | 0 to 60 phr aluminum trihydrate or |
| | magnesium dihydrate |
| | 5 to 15 phr wax |
| | 0 to 5 phr ZnO |
| | 2 to 15 phr silane |
| | 2 to 5 phr antioxidizer |
| | 0 to 15 phr cross-linking agent |

Where phr means parts by weight per 100 parts of resin.

What is claimed is:

1/ An electrically insulating composition that withstands high temperature T, the composition comprising a first component constituted by an organic polymer having a decomposition temperature lower than said temperature T, a second component constituted by a fusible ceramic filler having a melting temperature lower than said temperature T, and a third component constituted by a refractory filler having a melting temperature higher than said temperature T, wherein the fusible ceramic filler content is less than or equal to 50 parts by weight per 100 parts by weight of polymer.

2/ A composition according to claim 1, wherein said polymer is ethylene copolymer.

3/ A composition according to claim 2, wherein said polymer is ethylene-octene copolymer or a mixture based on ethylene-octene copolymer.

4/ A composition according to claim 1, the composition being implemented by silane cross-linking.

5/ A composition according to claim 1, wherein said fusible ceramic filler is selected from boron oxide, zinc borates, and boron phosphates, or a mixture of said components.

6/ A composition according to claim 1, wherein said refractory filler is selected from magnesium oxide, silicon oxide, aluminum oxide, and muscovite mica, or a mixture of said fillers.

7/ A composition according to claim 1, comprising:
100 parts by weight of ethylene-octene copolymer or of a mixture based on ethylene-octene copolymer;
100 to 200 parts by weight of magnesium oxide;
5 to 50 parts by weight of boron oxide or of zinc borate or of boron phosphate; and
5 to 150 parts by weight of other fillers and processing agents and protection agents.

8/ A composition according to claim 1, comprising:
100 parts by weight of ethylene-octene copolymer or of a mixture based on ethylene-octene copolymer;
100 to 200 parts by weight of muscovite mica;
5 to 50 parts by weight of boron phosphate or of zinc borate; and
5 to 150 parts by weight of other fillers and processing agents and protection agents.

9/ An electric cable comprising at least one conductor coated in an inner first layer of insulation and in an outer second layer of insulation, wherein said first layer is constituted by a composition in accordance with claim 7, and the second layer is constituted by a composition in accordance with claim 8.
